(19) United States
(12) Patent Application Publication
(10) Pub. No.: US 2008/0163272 A1
(43) Pub. Date: Jul. 3, 2008

(54) Guiding System for Guiding an Object Along a Motor Driven Spindle and Module Equipped with Such Guiding System

(75) Inventors: Horst Rumpf, Herborn (DE); Szilard David, Gyor (HU)

Correspondence Address: WPAT, PC, 7225 BEVERLY ST., ANNANDALE, VA, 22003, US

(73) Assignee: KONINKLIJKE PHILIPS ELECTRONICS, N.V., EINDHOVEN (NL)

(21) Appl. No.: 11/720,523

(22) PCT Filed: Nov. 29, 2005
(86) PCT No.: PCT/IB05/53951

§ 371 Date: May 31, 2007

(30) Foreign Application Priority Data
Dec. 6, 2004 (EP) 04106315.7

(51) Int. Cl. G11B 17/03

(52) U.S. Cl. 720/613

(57) ABSTRACT

The invention relates to a guiding system (10, 10′) for guiding an object (3), for instance an optical read/write-unit (3) of an optical disc player, along a motor driven spindle (5). The guiding system (10, 10′) comprises engaging means (12) for engaging the spindle (5) and biasing means (15) for having the engaging means (12) engage the spindle (5) with a certain spindle force (F_{spindle})- To improve, i.e. minimize loading of the spindle, the engaging means (12) and biasing means (15) are arranged in such way, that the spindle forces (F_{spindle}) exerted on the spindle (5) cancel each other out, so that their total sum, and preferably also the sum of the moments on said spindle (5) approaches zero. The invention furthermore relates to a module (1) for an optical disc player, provided with an optical read/write-unit (3), a drive system and a guiding system (10, 10′) according to the invention.

The invention relates to a guiding system for guiding an object, for example an optical read/write unit, along a motor driven spindle.

Motor driven spindles are commonly used in for instance CD-, DVD- or Blue Ray Disc players, to move a read/write-unit along a disc. To ensure good engaging contact between the spindle and the read/write-unit, said unit is equipped with a guiding system, comprising spindle engaging means, such as a nut, gearwheel or other threaded or toothed part, and biasing means, such as a preloaded spring, to bias the engaging means into engaging contact with the spindle and overcome play which may occur between the spindle and the engaging element, due to for instance manufacturing tolerances or wear.

A disadvantage of this known guiding system is that the force, exerted by the engaging means on the spindle, induces a reaction force in the motor and bearing supporting the spindle. Moreover, the spindle force and reaction forces subject the spindle to a bending moment. Together, these forces and moment may account for about 50 to 80% of the total motor load. This prevents the motor from being downsized, which is particularly troublesome in before mentioned CD- and DVD applications, where consumers ask for ongoing miniaturisation. Moreover, the load on the motor and bearings affects the lifetime thereof. It also causes increased friction between the bearings and spindle, which may give rise to non-linear dynamic behaviour, such as stick slip, which in turn may seriously compromise the accuracy of the system, in particular its jump performance, wherein the object must quickly cover a predetermined distance.

It is therefore an object of the invention to provide a guiding system of the above described type, wherein at least part of the disadvantages of the known guiding system are overcome, while maintaining the advantages thereof. More particular it is an object of the invention to minimise the load on the spindle, bearings and/or motor, while keeping the engaging means in close contact with the spindle.

To that end, a guiding system according to the invention is characterised by the features of claim 1. Particularly, the object is achieved by the guiding system according to the invention, which system comprises engaging means for engaging the spindle and biasing means for having the engaging means engage the spindle with a certain spindle force, wherein the engaging means and biasing means are arranged to engage the spindle at several positions along its circumference, thereby exerting a spindle force at each position, wherein said positions, the orientation and/or the magnitude of the spindle forces are chosen such that the sum of these forces equals or approaches zero.

By arranging the engaging means at several locations around the spindle's circumference and by setting the biasing means appropriately, it is possible to have the spindle forces, exerted by the engaging means, cancel each other out, so that the resultant force (the sum of the individual spindle forces) equals or approaches zero. In this way, good engaging contact can be achieved between the engaging means and spindle, without increasing the load on the spindle and motor.

In a most simple embodiment the engaging means and biasing means can be arranged at diametrically opposed sides of the spindle, having the engaging means exert biasing forces of equal magnitude but opposed sign. In a more complex configuration, the engaging means may engage the spindle at more than two locations, whereby the points of application, orientation and magnitude are selected such that the sum of their horizontal and vertical components cancel each other out.

In a similar fashion, by arranging the various engaging means appropriately it can be achieved that the individual moments, exerted on the spindle by the respective engaging means, cancel each other out so that the total sum is zero or approaches zero. This too helps to minimize the load on the spindle, so that this spindle, together with its supporting bearings and driving motor can be minimized, and lifetime thereof can be elongated.

In a preferred embodiment, the guiding system may be pivotally connected to the object to be driven, around a pivot axis that extends substantially parallel to the centre line of the spindle. Thanks to such pivotal connection, the guiding system can adjust for small sideward deviations of the spindle position relative to the object, which may for instance occur due to manufacturing inaccuracies. In such case, the guiding system will simply rotate around said pivot axis, thereby keeping the arrangement of the engaging means with regard to the spindle substantially in tact, and with that the advantageous load distribution along the spindle.

In a further preferred embodiment, the guiding system may comprise coupling means of adjustable length, for coupling the engaging means to the object to be driven. Such adjustable length may for instance be realized by a pantograph-like configuration or a telescopic arrangement. The length adjustment allows the guiding system to compensate for deviations of the spindle position relative to the driven object in upward/downward direction, so that in case of such deviations, the engaging means can maintain their advantageous position with regard to said spindle. Such adjustable length may further, in combination with aforementioned pivotal connection, allow the guiding system to adjust its orientation for relative large sideward deviations of the spindle position, without affecting the position of the engaging means with regard to said spindle.

The invention also relates to a module for an optical disc player, for example a CD-, DVD- or Blue Ray-player, provided with a guiding system according to the invention. Thanks to such guiding system, the spindle will not be unnecessary loaded and the driving motor and supporting bearings can be minimised, enabling the overall device to be seized down. Moreover, lifetime may be increased and performance may be improved, thanks to reduced friction between the spindle and supporting bearings. The invention further relates to an optical disc player provided with such a module.

Further advantageous embodiments of the guiding system, the module and the disc player according to the invention are set forth in the dependent claims.

To explain the invention, exemplary embodiments thereof will hereinafter be described with reference to the accompanying drawings, wherein:

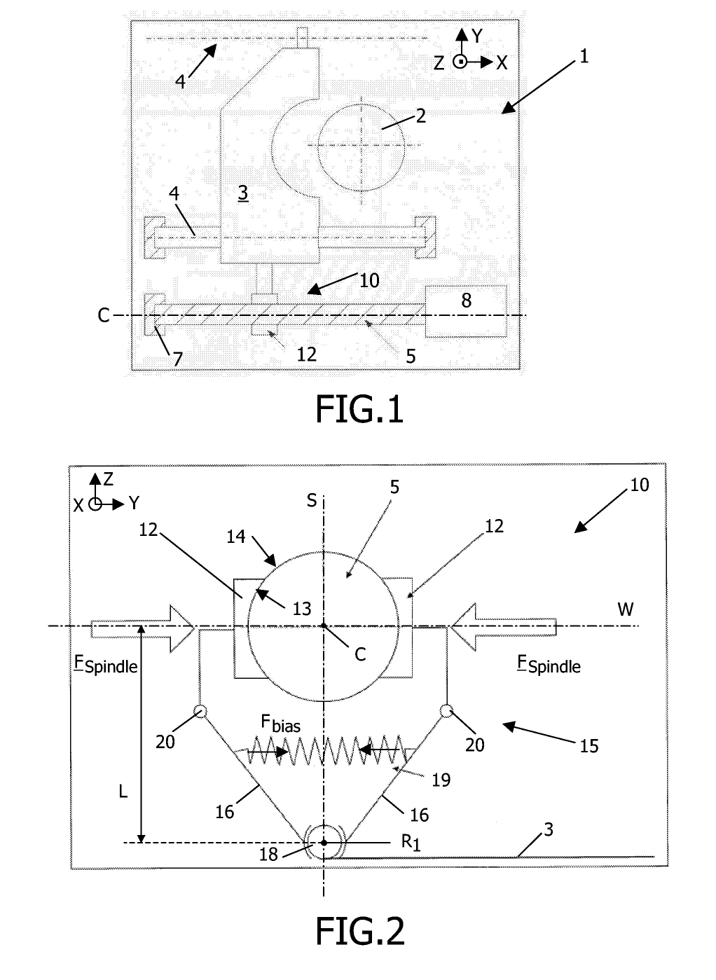

FIG. 1 shows in top plan view a read/write-module, provided with a guiding system according to the invention;

FIG. 2 shows in more detail a first schematic embodiment of a guiding system according to the invention for illustrating the working principle thereof;

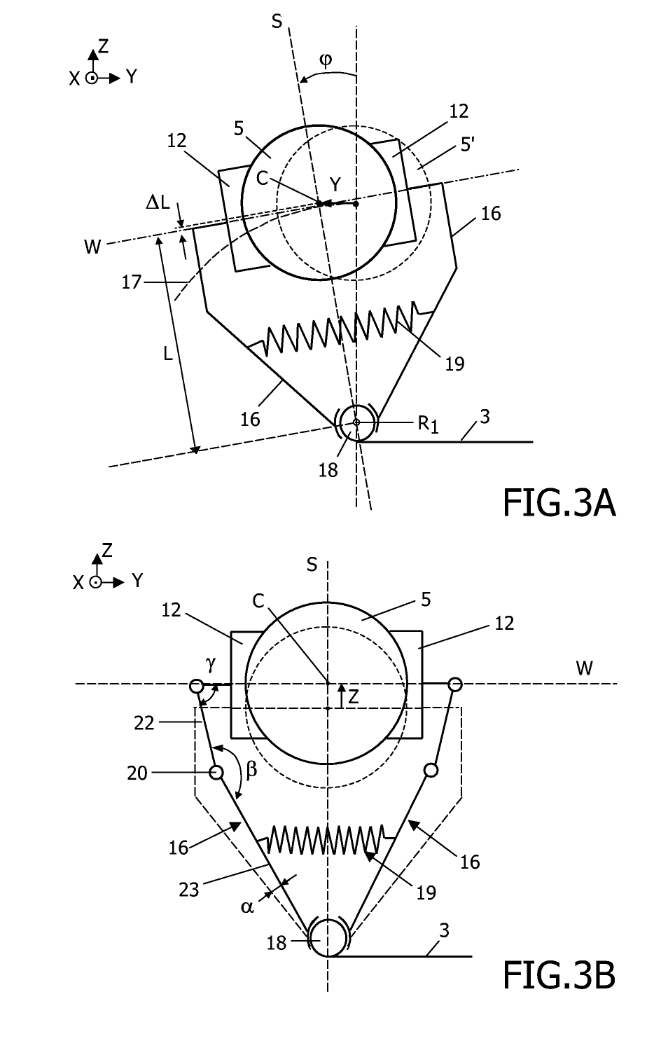

FIG. 3A shows the guiding system of FIG. 2 with the spindle having a sideward deviation in Y-direction, relative to the read/write-unit;

FIG. 3B shows the guiding system of FIG. 2, with the spindle having an upward deviation in Z-direction with respect to the read/write-unit;

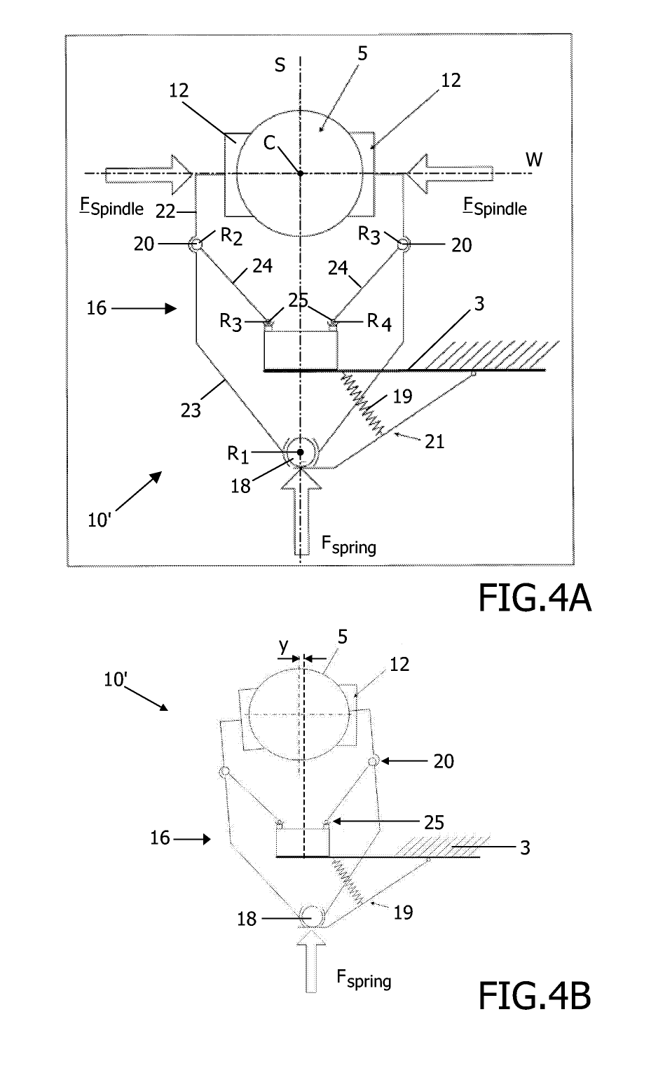

FIGS. 4A,B show an alternative, schematic embodiment of a guiding system according to the invention, with the spindle having zero deviation, respectively a small sideward deviation; and

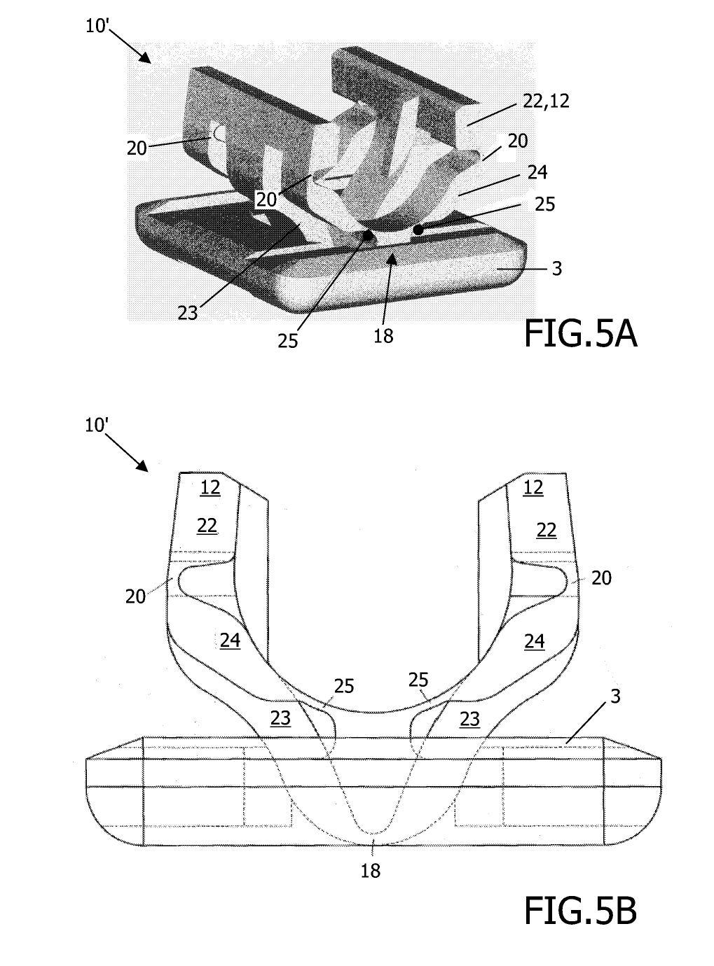

FIGS. 5A,B show a practical implementation of the guiding system of FIG. 4, in frontal view and in perspective view respectively.

FIG. 1 shows in top plan view schematically a read/write-module 1 for for instance a CD-, DVD- or Blue Ray Disc-player. The module 1 comprises a motor driven turntable 2 for receiving and spinning a disc (not shown), an (optical) read/write-unit 3 for reading, writing and/or otherwise processing information on said disc, and a motor driven spindle 5 for moving the read/write-unit 3 along a surface of the disc. The spindle 5 is near one end rotatably supported in a bearing 7 and near its other end supported by the driving motor 8. The read/write-unit 3 is slideably supported on rails, rods or other suitable guiding means 4 and is equipped with a guiding system 10 according to the invention for engaging and be guided along the spindle 5.

The basic principle underlying the guiding system 10 according to the invention will now be described in more detail with reference to FIG. 2, showing the spindle 5 of FIG. 1 in cross sectional view, engaged by a first schematic embodiment of a guiding system 10. In this embodiment, the guiding system 10 comprises engaging means 12, in the form of two nut segments, which engage the spindle 5 at diametrically opposed positions. Each nut segment 12 is provided with a threaded or toothed, cylindrical contacting surface 13, which matches a threaded, cylindrical outer surface 14 of the spindle 5.

The guiding system 10 further comprises biasing means 15, to have the engaging means 5 engage the spindle 5 with a certain spindle force F_{spindle}, as illustrated in FIG. 2. To that end, the biasing means 15 include two slightly curved or hooked arms 16, which near one end are connected to a respective nut segment 12 and near their other end are pivotally connected to the read/write-unit 3, around a first pivot axis R₁ that extends substantially parallel to a centre line C of the spindle 5. In the illustrated embodiment, both arms are connection to the unit 3 via a single pivot joint 18, but it will be appreciated that in alternative embodiments, the arms 16 can be connected by two separate pivot joints, of which the respective pivot axes do not even have to coincide. However, in the latter case, the axes preferably extend mirror symmetric with regard to a plane of symmetry S, to be described below. The biasing means 15 furthermore include a spring 19, which is mounted between the arms 16 and is pre-tensioned so as to pull the arms 16 towards each other with a biasing force F_{bias}.

As best seen in FIG. 2, the arms 16, nut segments 12 and spring 19 are symmetrically disposed with regard to a plane of symmetry S, extending through said centre line C of the spindle 5 and the first pivot axis R1. The biasing force F_{bias} of spring 19 extends substantially parallel to a work line W of the spindle forces F_{spindle}, which work line W in turn extends substantially perpendicular to said plane of symmetry S, through the centre line C of the spindle 5.

Thanks to such symmetric arrangement, the spindle forces F_{spindle} exerted by the nut segments 12 will be each of equal but opposed magnitude, i.e. half the magnitude of he biasing force F_{bias}, thereby causing the resultant force on the spindle 5 to be zero or at least approach zero. Consequently, the load exerted on the spindle bearing 7 and/or motor 8 by the read/write-unit 3 via the engaging means 12 is minimized, if not negligible all together.

In a preferred embodiment, the arms 16 are each provided with an additional pivot joint 20, thereby dividing the arm in a distal segment 22 and a proximal segment 23, which can pivot with respect to each other around a second, respectively third pivot axis R₂,R₃, extending substantially parallel to the first pivot axis R₁. Thanks to this additional pivot joints 20, the guiding system 10 according to the invention is able to maintain the abovementioned advantageous symmetric spindle loading, even if the spindle position is deviated with respect to the read/write-unit 3, for instance due to manufacturing inaccuracies. This will be explained with reference to FIGS. 3A and 3B, illustrating two situations wherein the spindle 5 has been shifted to the left, over a distance Y, respectively upward, over a distance Z.

Starting with FIG. 3A, it is seen, that the sideward shift of the spindle 5 causes the arms 16, nut segments 12, work line W and plane of symmetry S to rotate around the first pivot axis R₁ over an angle φ, whereby the mentioned parts maintain their respective orientations with respect to each other. However, with this rotation, the work line W of the nut segments 12 will no longer extend exactly through the centre C of the spindle 5, but at a distance ΔL therefrom (which in FIG. 3A is exaggerated, for clarity sake). Consequently, the spindle forces F_{spindle} exerted by the nut segments 12 will not exactly be diametrically opposed. This effect is negligible small for small angles φ, but will gain influence with larger angles φ (corresponding to larger deviations Y). This can be seen from curve 17, presenting in dashed lines the path travelled by the point of intersection of the work line W and the plane of symmetry S. Basically, this curve 17 corresponds with a circle around the first pivot axis R₁, with radius L, wherein L represents the (original) distance between the first pivot axis R₁ and the workline W with the guiding system 10 in undeflected position as shown in FIG. 2.

From the above discussion it is clear, that to adjust for relatively large deviations in Y-direction (or large angles φ) the length L of the guiding system 10 needs to be adjustable. A similar adjustment is required when the spindle position features a deviation in upward or downward direction Z (as illustrated in FIG. 3B). Such adjustment is in the present embodiment possible thanks to the pivot joints 20. Referring now to FIG. 3B, it is seen that when the spindle 5 is shifted upward, over a direction Z, from its original position (which is shown in dashed lines) the arms 16 will be stretched. More specifically, the proximal arm segments 23 will rotate towards each other around the first pivot axis R₁, thereby decreasing an angle α between said arms 23, whereas the distal arm segments 22 will rotate in opposite direction, around the second and third pivot axis R₂, R₃ respectively, thereby increasing an angle β between the distal and proximal arm segments 22, 23.

Preferably the engaging means 12 are pivotally connected to the distal arm segments 22, via two additional pivot joints, as illustrated in FIG. 3B, allowing the engaging means 12 to remain diametrically aligned, by adapting their orientation (angle γ) relative to said arm segments 22.

Thus, the biasing means 15 can retain their symmetric arrangement with regard to the plane of symmetry S, thereby ensuring that the spindle forces F_{spindle} are of substantially equal, opposed magnitude, so that the resulting force on the spindle 5 is zero or close thereto. Of course, if the spindle 5 is shifted in opposite direction (not shown), the proximal and distal arm segments 22, 23 will pivot in reversed direction around their respective pivot axes R_{1,2,3}. Furthermore, in practice the spindle position may be deviated both sideward and up- or downward, whereby the guiding system 10 will enable a combination of the adjustments shown in FIGS. 3A,B.

In many applications, amongst others in above mentioned CD-, DVD- or Blue ray disc-modules 1 the spindle diameter may be quite small, e.g. in the order of a few millimetres only. Consequently, the available space for spring 19 between the arms 16 may be very small, if not too small. FIG. 4A therefore presents an alternative embodiment of a guiding system 10′ according to the invention, particularly (but not exclusively) suitable in applications with such limited space. Parts corresponding to parts of the earlier embodiment are denoted with corresponding reference numerals.

The embodiment shown in FIG. 4A differs from the one shown in FIG. 2 in that two additional arms are provided, hereinafter referred to as help arms 24. These help arms 24 are each pivotally connected to the read/write-unit 3 around a fourth and fifth pivot axis R_{4,5}, extending substantially parallel to each other and the other pivot axes R₁₋₃. Each help arm 24 is near its other end coupled to the first arms 16, near the second and third pivot joints 20 of said arms 16. Another difference with the embodiment of FIG. 2, is that the first pivot joint 18, with its associated pivot axis R₁, does no longer connect the guiding system 10′ to the read/write-unit 3 (this function is taken over by the help arms 24), but instead is biased towards the spindle 5 by spring means 19, arranged to press said pivot joint 18 against a portion 21 of the read-write-unit 3, which is pivotally connected to a main body of said read/write-unit 3. The first pivot joint 18 pivotally connects the arms 16. Preferably, the spring means 19 are selected to have a relatively weak spring stiffness in combination with a relatively high pretension. This helps to render said spring means 19 less sensitive for mechanical tolerances in the system.

By biasing the pivot joint 18 this way, the proximal ends 23 of the main arms 16 will be pushed away from each other, causing the distal ends 22 to move towards each other and the nut segments 12 to exert a spindle force F_{spindle} on the spindle 5, at diametrically opposed positions. Thanks to the symmetric arrangement of the biasing means with regard to the plane of symmetry S, these spindle forces F_{spindle}, like in the previous embodiments, will be of substantially equal magnitude. It will furthermore be appreciated that the respective arms 16 and 24 can, thanks to their pivot joints 18, 20, 25 adjust their relative orientation, in a similar way as discussed for the embodiments of FIG. 3A and 3B, so as to compensate for deviations of the spindle position in Y and Z-direction.

This is schematically illustrated in FIG. 4B, for a deviation of the spindle 5 in Y-direction. As can be seen from this FIG. 4B, the deviation Y causes the arms 16 to rotate around pivot joint 18, without changing their relative position. The help arms 24 are each pivoted around their respective pivot joints 25, in such way that their opposite arm ends continue to support the arms 16 at the pivot joint 20.

FIGS. 5A, B show a practical embodiment of the schematic guiding system 10′ of FIG. 4, in frontal view and perspective view respectively. Parts known from the embodiment of FIG. 4 have been identified with corresponding reference numerals. The operating principle of this embodiment is as explained in relation to FIG. 4. In this practical embodiment, all parts have been integrally manufactured, preferably of plastic, for instance by injection moulding. Of course, alternative implementations are possible, which are not integrally made of one piece.

The invention is not in any way limited to the exemplary embodiments presented in the description and drawings. Combinations (of parts) of embodiments shown and described in this description are explicitly understood to fall within the scope of the invention as well. Moreover, many variations are possible within the scope of the invention, as outlined by the claims.

1. Guiding system (10, 10′) for guiding an object (3), for example an optical read/write-unit (3), along a motor driven spindle (5), comprising engaging means (12) for engaging the spindle (5) and biasing means (15) for having the engaging means (12) engage the spindle (5) with a certain spindle force (F_{spindle}), wherein the engaging means (12) and biasing means (15) are arranged to engage the spindle (5) at several positions along its circumference, thereby exerting a spindle force (F_{spindle}) at each position, wherein said positions, the orientation and/or the magnitude of the spindle forces (F_{spindle}) are such that the sum of these forces equals or approaches the value zero.

2. Guiding system (10, 10′) according to claim 1, wherein the positions, orientation and/or magnitude of the spindle forces (F_{spindle}) are chosen such that the resulting moment on the spindle (5), exerted by said spindle forces (F_{spindle}) equals or approaches zero.

3. Guiding system (10, 10′) according to claim 1, wherein the engaging means (12) are arranged to engage the spindle (5) at diametrically opposed positions, thereby exerting on said spindle (5) spindle forces (F_{spindle}) of substantially equal magnitude but opposed sign.

4. Guiding system (10, 10′) according to claim 1, wherein this system (10, 10′) is coupled to the object (3) by means of a pivot joint (18), so as to be pivotal around a first pivot axis (R₁), which extends substantially parallel to a centre line (C) of the spindle (5).

5. Guiding system (10, 10′) according to claim 4, wherein the biasing means (15) are symmetrically arranged relative to a plane of symmetry (S), extending through the centre line (C) of the spindle (5) and the first pivot axis (R₁).

6. Guiding system (10, 10′) according to claim 1, wherein the guiding system (10, 10′), in particularly the engaging means (12) thereof, are coupled to the object (3) to be driven, via coupling means (16) having an adjustable length (L).

7. Guiding system (10, 10′) according to claim 1, wherein the biasing means (15) comprise at least two arms (16) and spring means (19), wherein said arms (16) are connected to a pair of diametrically opposed engaging means (12), wherein furthermore each arm (16) is pivotally connected around a pivot axis (R₁), which extends substantially parallel to a centre line (C) of the spindle (5), and wherein he spring means (19) engage the arms (16), so as to force said engaging means (12) towards each other.

8. Guiding system (10, 10′) according to claim 7, wherein the arms (16) are pivotally connected around a common pivot axis (R₁).

9. Guiding system (10, 10′) according to claim 8, wherein the common pivot axis (R₁) of the arms (16) substantially coincides with a first pivot axis (R₁) of a pivot joint (18) with which the guiding system (10, 10′) is coupled to the object (3).

10. Guiding system (10, 10′) according to claim 7, wherein the spring means (19) are substantially located outside a space defined by said arms (16) and the engaging means (12).

11. Guiding system (10, 10′) according to claim 7, wherein each arm (16) is provided with at least one additional pivot joint (20), of which the respective pivot axes extend substantially parallel to the other pivot axis (R₁) of said arm (16).

12. Guiding system (10, 10′) according to claim 1, wherein the engaging means (12) and biasing means (15) are integrally manufactured, for instance moulded from plastic.

13. Module (1) for an optical disc player, for reading, writing or otherwise processing data on a disc, in particular a CD, DVD or Blue ray disc, said module (1) comprising an optical read/write-unit (3) and a motor driven spindle (5), to drive said read/write-unit (3) along the disc, wherein the read/write-unit (5) engages the spindle (5) via a guiding system (10, 10′) according to claim 1.

14. Optical disc player provided with the module according to claim 13.
